(19) United States
(12) Patent Application Publication
(10) Pub. No.: US 2019/0085815 A1
(43) Pub. Date: Mar. 21, 2019

(54) The Barton float generator

(71) Applicant: Antonio Jacob Barton, warren, MI (US)

(72) Inventor: Antonio Jacob Barton, warren, MI (US)

(21) Appl. No.: 15/706,700

(22) Filed: Sep. 16, 2017

(51) Int. Cl. F03B 13/18; H02K 35/02

(52) U.S. Cl. CPC F03B 13/1855; H02K 35/02

(57) ABSTRACT

The Barton Float Generator is a device that uses water currents, water waves or water elevation changes to push/pull magnets threw electrical coils to generate electrical energy. The barton float generator will also be composed of a float, a yellow pole, two check valves, two tubes, 4 electrical coils and 8 magnets with 3 spacer in between them.

### BACKGROUND

### Field of Invention

The Bartons Float Generator is a device which is generated toward the art of generating alternative energy using water currents, water waves or water elevation changes.

### Description of Related Art

Currently the state of this art is there are very few devices devoted to the art of alternative energy that are efficient, effective and practical.

### BRIEF SUMMARY OF INVENTION

The purpose of the Bartons Float Generator is to provide alternative energy that is effective, efficient and practical. Unlike other devices that generate electrical power from water currents, water waves or water elevation changes, The Barton Float Generator uses elevation changes to generate electrical energy. Other devices that use these methods, only generate an electrical charge when a particular motion is generated. For example, these devices rely on an elevation rise or a wave to positively change the elevation of the device to generate an electrical charge; if there is a negative elevation change in the water the device does nothing. This makes them ineffective and not versatile, where the Barton Float Generator can generate an electrical charge equal to a positive or negative change in elevation. The Barton Float Generator does not use motors, gears or dangerous chemicals making the Barton Float Generator cleaner safer and more cost effective while maintaining efficiency and practicality. The Barton Float Generator consists of a float which will move up or down in relation to the water current, water waves or changes in water elevation. This float will then move a magnetic field to generate electric energy through Faraday's Law of Induction.

### DESCRIPTION OF DRAWINGS

In FIG. 1, each individual part is are drawn in two dimension and is labeled. The float, 1, will be the object that will rest upon the body of water and will raise up when in contact with a wave or a change in water elevation. The plastic pole, 2, will be colored yellow and will be affixed into the middle of the float. Next is a total of 8 N42 grade or stronger magnets, 3, they are attached to the plastic pole in groups of four with a two smaller magnets (6). This smaller magnets of a total of four (6), will be placed on top and bottom of the two sets of the larger magnets (3). In Between the larger magnets (3), will be a plate to prevent blockage caused by buildup of any foreign material, 8. Next is two plastic orange tubes, 4, which the magnets (3&6) and the plates in between (8) will feed into. Four fully insulated electrical coils, 5, will be attached around the tubes (4) and finally two check valves, 7, will allow air or water build up in the device to be released while allowing none in, they will be driven into each of the orange plastic tubes (4).

In FIG. 2, the parts are drawn in three dimensional to show, how The Barton Float Generator will be assembled. The float (1) is the center of the device. The yellow plastic pole (2), is once affixed driven in the middle and attached to the float (1). Once affixed to the float, the twelve magnets and six plates (3&6), will be attached in a group to the plastic pole (2). Then the magnets with the plates in between them (3,6&8), will be fed into the plastic tubes (4). The four electric coils (5), will be attached around the two tubes (4) with the two check valves (7) driven into the tubed (4). This whole device must affixed vertically. Once this is done the complete assembly is now complete and the Barton Float Generator is now ready to be used.

In FIG. (3) we see The Bartons Float Generator in two dimensional illustration to show the reader another illustration of the assembly of The Barton Float Generator.

In FIG. 4, The Barton Float Generator is fully assembled with the twelve magnet's (3&6) and the six plates (8) semi encased into the top and bottom orange tubes (4). FIG. 4 illustrates the Barton Float Generator in a rested state of a body of water.

FIG. 5 is what the Barton Float Generator will look like from both top and bottom view. The float (1) is not seen in this illustration because it will be covered by the four fully insulated electric coils (4).

In FIG. 6 this shows the action of The Barton Float Generator. As the elevation changes which causes the float to raise up. As the float raises up, the yellow plastic pole (2) goes with it. The twelve attached magnets (3&6) and six plates (8), pass thru the top and bottom tubes (5). The magnetic force from the magnets is then passed through the four fully insulated electrical coils (4), and an electrical charge is generated via induction. During this time, any pressure inside caused from air or water will be release outside of the device by the two check valves (7).

FIG. 7 illustrates a continuation of FIG. 6, in this illustration the elevation change has become slightly negative. The Float (1) is lowered. The yellow plastic pole (2) follows the Float (1). The twelve magnets (3&6) and plates (8) are lowered through the top and bottom orange tube (5). Even though the assembly is lowered to the resting position (2), the magnetic force is then passed through the four fully insulated electrical coils (4) and an electrical charge is generated once again.

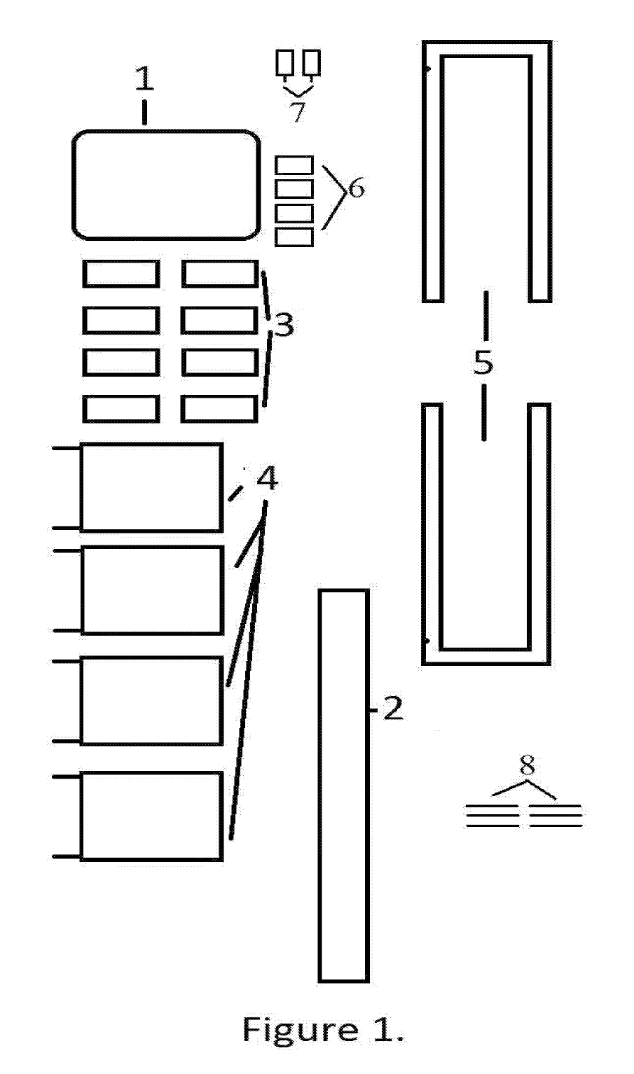

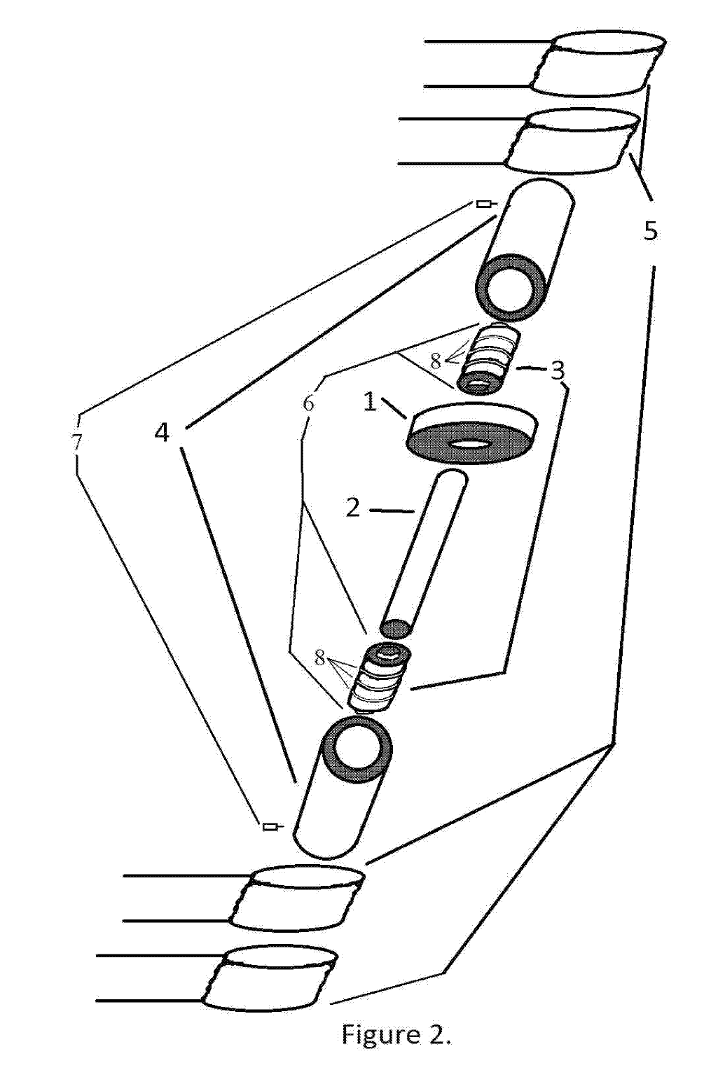

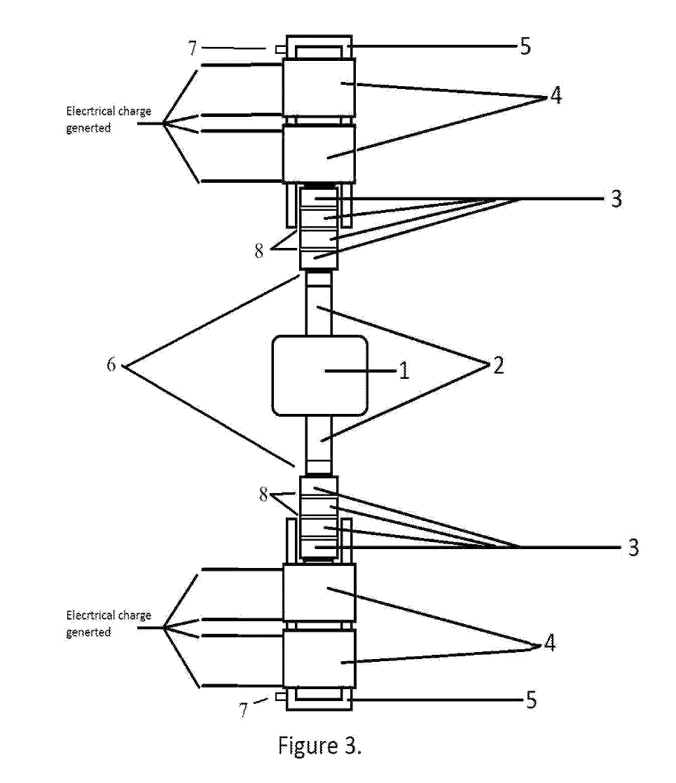

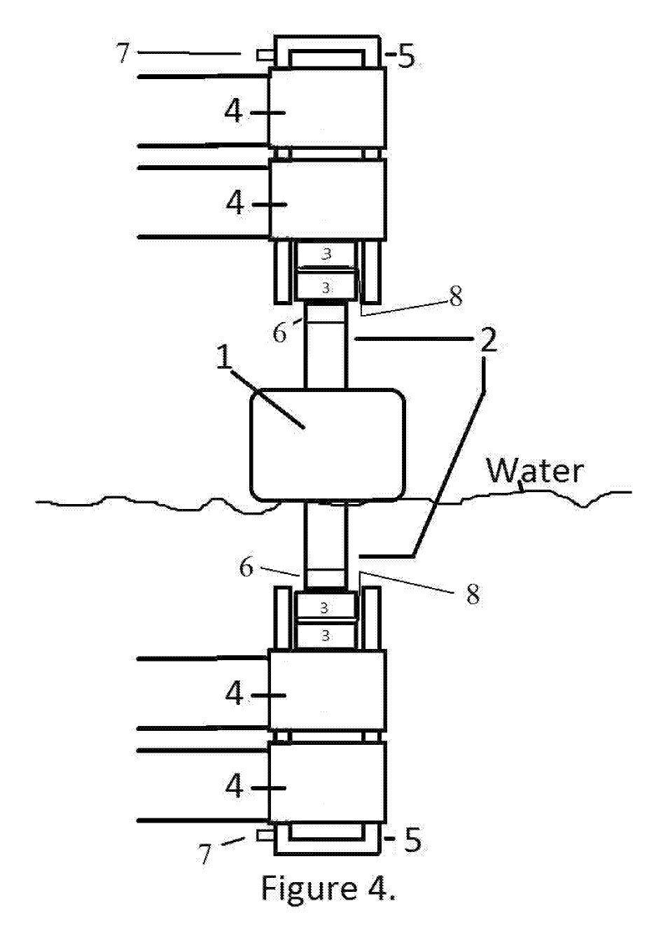

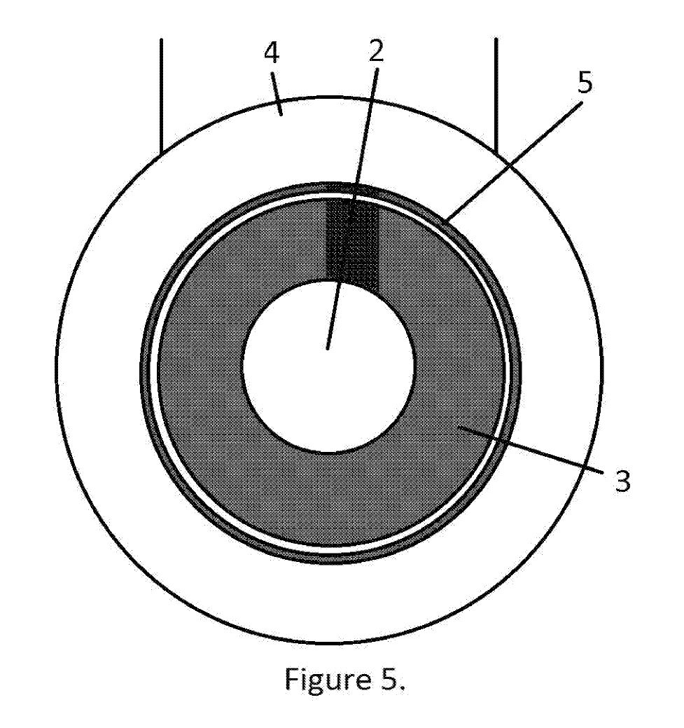

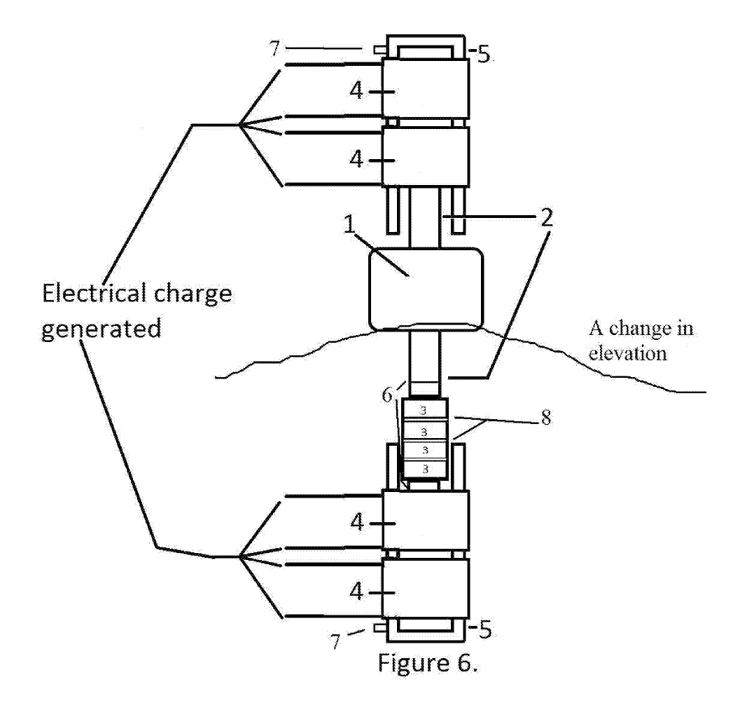

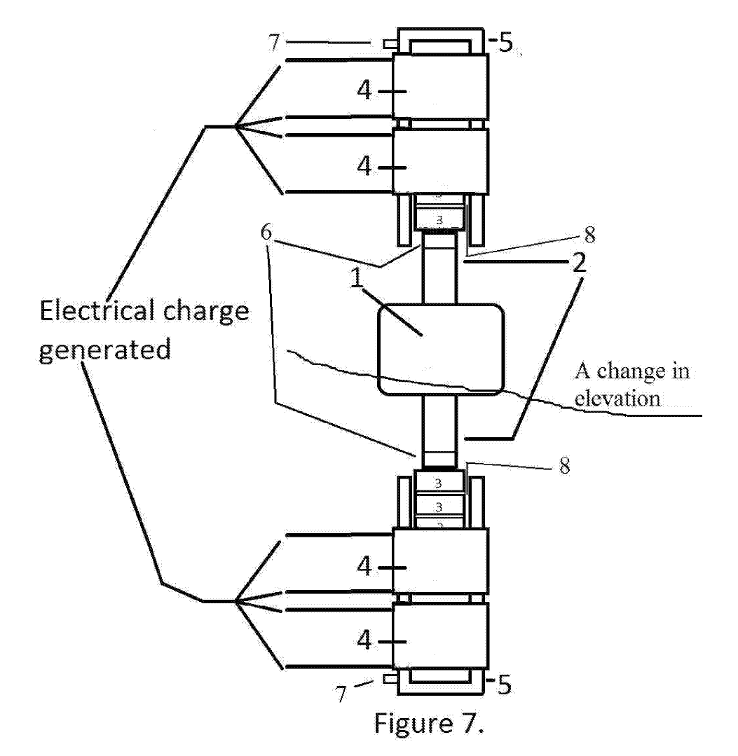

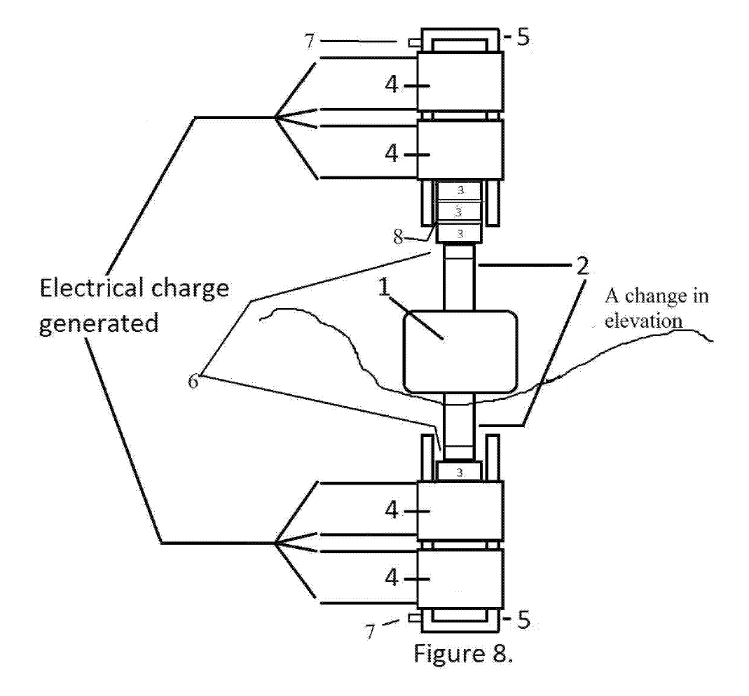

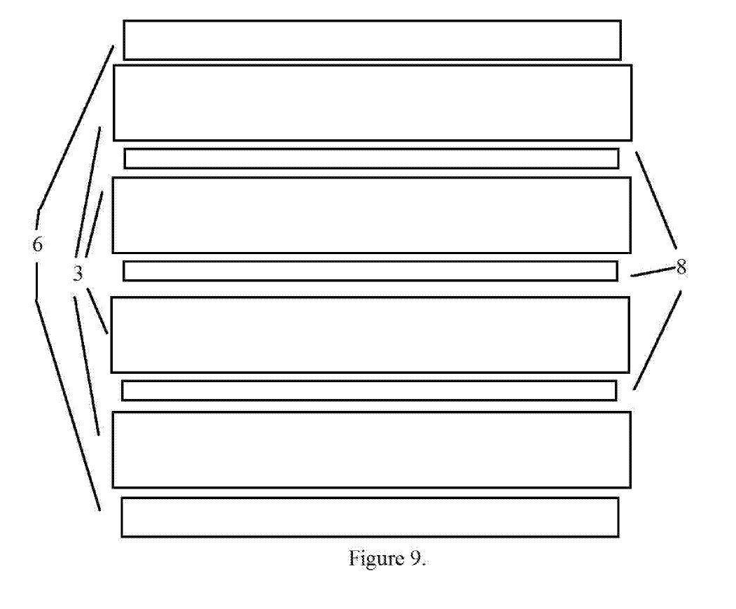

In FIG. 8, The Barton Float Generator reacts to a negative elevation change compared to the normal resting state described in FIG. 2. The Float descends with the water, the plastic pole follows. The magnets and plates descends and the magnetic force once again passes through the electrical coils, generating Electrical energy via induction. During this action if any pressure in the tubes is caused by air or water is once again released outside of the device by the two check valves (8).

In FIG. 9, one set of the magnets and plate's assembly is better shown. The two smaller magnets (6) surround the four much larger magnets (3). In Between the larger magnets are the three plates (8).

1-3. (canceled)

4. A d6evice which uses a change in elevation in a body of liquid to move a set of N40 magnets to generate an electrical current.

5. A vertically erected device which uses change in elevation in a body of liquid to generate electrical current, comprising of:
a. Positively or negatively moving a float vertically that has a yellow pole affixed with two sets of four N40 magnets.
b. Three plates in between the eight magnets and two smaller N42 magnets at the top and bottom of each set of four.
c. Each set of magnets and plates are then attached to the top and bottom of the yellow pole.
d. the yellow pole and magnets are fed into a two separate orange plastic tubes, one above the float and the other below.
f. Each orange plastic tubes will have two fully insulated of non-conductive coated electrical coils attached to them and one check valve drilled into the orange tubes.

6. The Barton Float Generator action comprises of:
a. Upon the change of elevation of the liquid, the float will naturally move to match the elevation.
b. Upon the floats movement, the yellow pole fixed to the float will push and pull two sets of four n40 strong magnets threw the center of the orange tube.
c. The magnetic force from the magnets movement will then cause induction upon the fully insulated, non-conducting coated magnetic coils and thus creating electrical current.
d. In the case that which a liquid may enter thru the orange tubes during normal operation and/or normal deterioration of the Barton Float Generator, the liquid will be drained out by the two check valves which will be drilled into the two orange tubes.
